(19) United States
(12) Patent Application Publication
(10) Pub. No.: US 2003/0159621 A1
(43) Pub. Date: Aug. 28, 2003

(54) Rare earth sulphide composition with improved chemical stability, preparation method and use thereof as pigment

(76) Inventor: Franck Fajardie, Villebon-sur-Yvette (FR)

Correspondence Address: BURNS DOANE SWECKER & MATHIS L L P, POST OFFICE BOX 1404, ALEXANDRIA, VA, 22313-1404, US

(21) Appl. No.: 10/239,917

(22) PCT Filed: Mar. 29, 2001
(86) PCT No.: PCT/FR01/00951

(30) Foreign Application Priority Data
Mar. 30, 2000 (FR) 00/04062

(51) Int. Cl. C04B 14/00; C04B 2/00

(52) U.S. Cl. 106/401; 106/415; 428/403

(57) ABSTRACT

The present invention concerns a composition based on a rare earth sulphide with improved stability, a process for its preparation and to use as a colouring pigment.

The composition of the invention is characterized in that it contains a support based on a rare earth sulphide and a layer based on at least one salt of said rare earth sulphide, a hydroxide, an oxide of said rare earth or an oxy and/or hydroxy derivative thereof, the salt, hydroxide, oxide and derivative being insoluble in water and/or in alcohols.

Said composition is obtained by acid attack of the surface of said support optionally followed by neutralisation.

The present invention relates to a composition based on a rare earth sulphide with improved chemical stability, to a process for its preparation and to its use as a pigment.

Mineral colouring pigments are already widely used in a number of industries, in particular the paint, plastics materials and ceramics industries. Of such pigments, a certain number of compositions contain sulphur. In particular, products based on rare earth sulphides have already been proposed by the Applicant as substitutes for pigments comprising metals which are known to be highly toxic, such as cadmium, lead, chromium and cobalt, the use of which is becoming more and more strictly regulated. Compositions based on rare earth sesquisulphides and alkaline elements have been described in European patent EP-A-0 645 746. Such compositions have been proved to be particularly advantageous substitutes. However, pigments based on sulphur generally suffer from the disadvantage of releasing H₂S during certain applications, for example when being incorporated into media such as polymers or precursors of such polymers and, when incorporated into polymers, when they are subjected to a relatively high temperature, for example at least 200° C. Thus, there exists a need for sulphur-based pigments with improved chemical stability as regards H₂S release.

Pigments based on rare earth sulphides and comprising a zinc compound have been developed by the Applicant and described in International patent application WO-A-97/20002. Such pigments have the property of only releasing very small quantities of H₂S, but this property must be still further improved, whence the aim of the present invention.

To this end, the composition of the invention is characterized in that it contains:

a support based on a rare earth sulplide;

a layer based on at least one salt of said rare earth sulphide, a hydroxide, an oxide of said rare earth or an oxy and/or hydroxy derivative thereof, the salt, hydroxide, oxide and the derivative being insoluble in water and/or in alcohols.

The invention also concerns a process for preparing a composition of the type defined above, characterized in that acid attack is carried out on the surface of said support and in that this attack is optionally followed by neutralisation.

Further characteristics, details and advantages of the invention will become apparent from the following description and non-limiting examples that are intended to illustrate the invention.

Throughout the description, the term “rare earth” means elements from the group constituted by yttrium and elements from the periodic table with atomic numbers from 57 to 71 inclusive.

Firstly, the composition of the invention includes a support forming a core, based on a rare earth sulphide.

The support can be based on a rare earth sulphide of the type Ln₂S₃, Ln being the rare earth, as described in EP-A-0 203 838.

This support can also be a sulphide of a rare earth and an alkali. More precisely, it can be a sulphide with formula ALnS₂ in which A represents at least one alkali and Ln represents at least one rare earth. More particularly, those with the following formulae can be cited: KLaS₂, NaCeS₂.

In a preferred variation, the sulphide contains at least one alkaline and/or alkaline-earth element at least a portion of which is included in the crystalline lattice of said sulphide. More particularly, said sulphide can be a sesquisulphide. Reference should be made to European patent application EP-A-0 545 746 the disclosure of which is hereby incorporated. It should be remembered that for this variation, the alkali element can in particular be selected from lithium, sodium and potassium. Clearly, the sulphide or sesquisulphide can comprise a plurality of alkali or alkaline-earth elements.

The alkali or alkaline-earth element is at least partially included in the crystalline lattice of the sulphide or sesquisulphide. In a particular embodiment, the alkali or alkaline-earth element is essentially or completely included in the crystalline lattice.

In particular, the sesquisulphide can have a Th₃P₄ type cubic crystallographic structure, which has voids in the cation lattice; this voided structure can be symbolized by giving the sesquisulphides the formula M_{10.66}[ ]_{1.33}S₁₆ (see in particular W H ZACHARIASEN, “Crystal chemical studies of the 5f series of elements. The Ce₂S₃-Ce₃S₄ type of structure”, Acta Cryst. (1949),2, 57).

The alkali or alkaline-earth elements can be introduced into the cationic voids up to saturation or otherwise of the latter. The presence of this element in the sulphide or sesquisulphide can be demonstrated by simple chemical analysis. Further, X ray diffraction analysis shows that the Th₃P₄ crystalline phase of the sesquisulphide is conserved with, in some cases, greater or lesser modification of the lattice parameters, a function of both the nature and the quantity of the alkali or alkaline-earth element introduced.

Generally, the quantity of alkali or alkaline-earth element is at most 50% of the molar quantity of the rare earth in the sulphide or sesquisulphide.

In a further preferred feature, the molar quantity of alkali or alkaline-earth element is at least 0.1%, and advantageously in the range 5% to 50%, more particularly 5% to 20%, of the molar quantity of rare earth.

In this varation comprising a sesquisulphide, the rare earth can more particularly be cerium or lanthanum. Still more particularly, the rare earth sesquisulphide is a γ cubic Ce₂S₃.

It is also possible to cite, as rare earth sulphides that can be used as a support in the context of the present invention, those described in European patent application EP-A-0 680 930, the disclosure of which is hereby incorporated. Those rare earth sulphides comprise at least one alkali element and they are constituted by whole mono-crystalline grains with a mean size of at most 1.5 μm. They are obtained by a process in which at least one rare earth carbonate or hydroxycarbonate is brought into contact with at least one compound of an alkali element and heated in the presence of at least one gas selected from hydrogen sulphide and carbon disulphide. These products also have a mean size (CILAS granulometry) that is generally less than 2 μm, more particularly in the range 0.7 to 1.5 μm. After disintegrating under mild conditions, the mean size can be at most 1.5 μm, advantageously in the range 0.3 to 0.8 μm.

The support based on a rare earth sulphide can also be constituted by a substrate on which a rare earth sulphide is deposited. This substrate can be a substrate of the mica, kaolin, silica, titanium oxide, alumina, graphite or iron oxide type, for example.

According to a principal characteristic of the invention, in addition to the support, the composition comprises a layer based on at least one salt of said rare earth sulphide, a hydroxide, an oxide of said rare earth or an oxy and/or hydroxy derivative thereof. Clearly, the salt is different from the rare earth sulphide of the support.

The term “salt” means a compound of the type LnₓA_{y} where Ln represents the rare earth element and A represents an anion, x and y being whole numbers the value of which depends on the valency and nature of Ln and A.

More particularly, the anion can be a sulphate anion (A═SO₄²⁻) or an orthophosphate anion (A═PO₄³⁻) Other anions can also be envisaged such as acetate, chloride or fluoride anions.

The layer can be based on a rare earth hydroxide or oxide, i.e., a compound with formula Lnₓ(OH)_{y} or LnₓO_{y} respectively, x and y being as defined above.

The term “oxy and hydroxy derivatives” means the following compounds:

oxy salts with formula LnₓO_{z}A_{y}, x, y and z being whole numbers the value of which depends on the valency and nature of Ln and A;

hydroxy salts with formula Lnₓ(OH)_{z}A_{y}, x, y and z being as hereinbefore defined;

oxyhydroxy salts with formula Lnₓ(OH)ₓO_{w}A_{y}, x, y w and z being as hereinbefore defined;

oxyhydroxides with formula LnₓO_{y}(OH)_{z}, x, y and z being whole numbers the value of which depends on the valency and nature of Ln.

The layer can be based on one of these compounds or on a mixture thereof in varying relative proportions.

A necessary condition is that the salt of the rare earth, hydroxide, oxide and derivative must be insoluble in water and/or in alcohols. The term “insoluble” means a solubility of less than 10⁻⁶ mole/l in the solvent or medium concerned.

This layer based on a salt, hydroxide, oxide or derivative is deposited on the support and at least partially coats the latter. This layer coating the support does not need to be perfectly continuous or homogeneous. However, preferably, this layer is uniform and continuous.

Further and preferably again, this layer has a controlled thickness. More precisely, the maximum thickness is that beyond which the coated rare earth sulphide would lose its pigmentary properties; generally, this thickness is at most 200 nm. More particularly, it can be at most 100 nm and preferably at most 20 nm. Further and normally, this layer is at least a few nanometers, for example at least 3 nm.

The continuous, homogeneous and controlled thickness disposition of the layer of salt, hydroxide, oxide or derivative is obtained when this layer derives from acid attack of the rare earth sulphide. Further, in this case, the bond between the layer and the support is particularly intimate.

Other variations of the invention will now be described.

In a first variation, the composition also comprises a layer based on at least one transparent oxide deposited on the support. Reference in this regard can be made to a product of this type comprising such a layer described in the Applicant's European patent application EP-A-0 620 254, the disclosure of which is hereby incorporated.

Here again, this peripheral layer coating the support need not be perfectly continuous or homogeneous. However, preferably, the compositions of this variation comprise a uniform coating layer that has a controlled thickness of transparent oxide, so as not to alter the original colour of the support prior to coating.

The term “transparent oxide” as used here means an oxide which, once deposited on the support in the form of a film of greater or lesser thickness, absorbs little or no light in the visible region, so that it only slightly or does not at all mask the intrinsic colour of said support. Further, it should be noted that the term “oxide” used for convenience in the present description must be taken to encompass hydrated type oxides as well.

Said oxides or hydrated oxides can be amorphous and/or crystalline.

Examples of such oxides that can in particular be cited are silicon oxide (silica), aluminium oxide (alumina), zirconium oxide (zirconia), titanium oxide, zirconium silicate ZrSiO₄ (zircon), and rare earth oxides. In a preferred variation, the coating layer is based on silica or a mixture of silica and alumina.

In a second variation, the composition further comprises a layer based on at least one zinc compound deposited on the support. The zinc compound may have been obtained by reacting a zinc precursor with ammonia and/or an ammonium salt. The zinc precursor can be a zinc oxide or hydroxide used in suspension. This precursor can also be a zinc salt, preferably a soluble salt. It can be a salt of an inorganic acid such as a chloride, or a salt of an organic acid such as an acetate. The form in which this zinc compound obtained is presented is not precisely known, but the zinc can be considered to be in the form of a zinc-ammonia complex with formula Zn(NH₃)ₓ(A)_{y} in which A represents an anion such as OH⁻, Cl⁻, the acetate anion or a mixture of anions, x being at most 4 and y being at most 2.

The invention also encompasses a third variation in which the composition further comprises fluorine.

For such a composition, reference concerning the particular disposition of the fluorine atoms can be made to the Applicant's patent application EP-A-0 628 608 the disclosure of which is hereby incorporated.

The fluorine-containing sulphides can have at least one of the following features:

the fluorine atoms are distributed in a concentration gradient which decreases from the surface to the core of said compositions;

the majority of the fluorine atoms are located at the external periphery of the compositions. The term “external periphery” here means a thickness, measured from the particle surface, of the order of several hundreds of Angstroms. Further, the term “majority” means more than 50% of the fluorine atoms present in the composition are located in said external periphery;

the percentage by weight of fluorine atoms present in the compositions does not exceed 10%, preferably 5%;

the fluorine atoms are present in the form of fluorinated or sulphofluorinated compounds, in particular in the form of rare earth fluorides or rare earth sulphofluorides (thiofluorides).

Clearly, the invention encompasses the case combining two or three of the variations described above.

In the case of the variations, the inner layer, i.e., the layer closest to the support, is generally based on the rare earth salt, hydroxide, oxide or derivative or the fluorine atom layer. The other layers can be disposed in any order. It is also possible for the zinc compound, the fluorine atoms and/or the transparent oxide to be present in the same layer, as a mixture, or again, these three elements can form a single layer with the rare earth salt, hydroxide or oxide or derivative.

A process for preparing the composition of the invention will now be described.

This process comprises acid attack of the support surface. The acid can be selected from those that are capable of supplying the anion A to form the salt, hydroxy salt or oxyhydroxy salt described above. However, it is also possible to work with another type of acid in the presence of a salt that can supply the anion A, for example ammonium sulphate which then provides the sulphate anion or with ammonium fluoride or chloride.

It is also possible to follow the acid attack with neutralisation. This neutralisation is carried out by treating the support with a base. It is possible to use alkali or alkaline-earth hydroxide type products or Ammonia. This neutralisation can produce compositions in which the layer comprises at least one rare earth hydroxide or a derivative of the type described above. In the case when this preparation includes neutralisation, it is possible to start from acids for which the rare earth salts can be soluble in water and alcohols. Nitric acid can be mentioned as an example of such acids.

Acid attack is generally carried out taking the support up into suspension in a liquid reaction medium then introducing the acid into the medium.

In a particular embodiment, attack is carried out with the acid and then optionally neutralised in an alcoholic medium. This alcoholic medium can be constituted by an alcohol selected from aliphatic alcohols such as butanol or ethanol.

Acid attack is carried out with a quantity of acid that depends on the thickness of the layer of salt, hydroxide, oxide or derivative to be formed and also on the grain size of the support.

Acid attack can be followed by ageing. During ageing, the reaction medium is kept at a constant temperature which can be in the range from ambient temperature to 200° C., preferably in the range 20° C. to 100° C., for example. The ageing period is generally at most 10 hours.

The treated product can be separated from the reaction medium then dried. Drying or ageing at high temperature can produce a rare earth oxide based layer.

When acid attack results in a salt, hydroxide, oxide or derivative of a rare earth in a given oxidation state, for example a cerium III oxide and when a salt, hydroxide, oxide or derivative of this same rare earth exists in a higher oxidation state, for example a cerium IV hydroxide, which is more insoluble in water than the corresponding species of the rare earth at the lower oxidation state, it is possible to carry out acid attack in the presence of an oxidising agent such as hydrogen peroxide, for example. A product is then obtained wherein the layer comprises the rare earth salt, hydroxide, oxide or derivative in the higher oxidation state and that product has an improved stability as regards H₂S release.

When preparing a composition that also comprises a layer based on at least one transparent oxide, acid attack is first carried out then the support and a precursor of the transparent oxide are brought into contact and the transparent oxide is precipitated onto said support.

Reference can be made to the disclosure in EP-A-0 620 254 for preparing a composition of this type. The preparation principle thus essentially consists of precipitating the oxide onto the support. Examples of processes will be given below for the different types of oxides, in which processes the oxide precursor can be an alcoholate.

When silica is used, mention can be made of preparing the silica by hydrolyzing an alkyl-silicate by forming a reaction medium by mixing water, alcohol, a support which is then taken up into suspension, and optional base, of an alkali fluoride or an ammonium fluoride which can act as a catalyst for the silicate condensation. The alkyl-silicate is then introduced. Then the alkaline silicate type silicate can be prepared by reacting the support with an acid.

When using an alumina-based layer, the support, an aluminate and an acid can be reacted to precipitate out alumina. This precipitation can also be achieved by bringing the support, an aluminium salt and a base into contact and reacting them.

Finally, the alumina can be formed by hydrolyzing an aluminium alcoholate.

Regarding titanium oxide, it can be precipitated by introducing a titanium salt such as TiCl₄, TiOCl₂ or TiOSO₄, and a base into a hydroalcoholic suspension. It is also possible to hydrolyse an alkyl titanate or to precipitate from a titanium sol, for example.

Finally, regarding a layer based on zirconium oxide, it is possible to co-hydrolyse or co-precipitate a suspension of cerium support in the presence of an organometallic zirconium compound, for example a zirconium alkoxide such as zirconium isopropoxide.

To prepare a composition comprising a base layer of at least one zinc compound, acid attack is first carried out then said support, a zinc precursor, ammonia and/or an ammonium salt are brought into contact and the zinc compound is deposited onto the support.

The zinc precursor can be a zinc oxide or hydroxide which is used in suspension. This precursor can also be a zinc salt, preferably a soluble salt. It can be an inorganic acid salt such as a chloride, or a salt of an organic acid such as an acetate.

It is also possible to use both ammonia and an ammonium salt at the same time.

In one advantageous feature, contact between the support, the zinc precursor, the ammonia and/or ammonium salt is carried out in the presence of an alcohol. The alcohol used can be the same type as that mentioned above in the case of acid attack, i.e., it is generally selected from aliphatic alcohols such as butanol or ethanol. In particular, the alcohol can be supplied with the zinc precursor in the form of an alcoholic solution of zinc.

In an advantageous variation of the invention, the support, zinc precursor, ammonia and/or ammonium salt are brought into contact in the presence of a dispersing agent. This dispersing agent is intended to prevent agglomeration of the particles forming the support during their suspension. It also allows more concentrated media to be used. It encourages the formation of a homogeneous layer over all of the particles.

This dispersing agent can be selected from the group formed by dispersing agents that function by dint of a steric effect, in particular non ionic hydrosoluble or organosoluble polymers. Dispersing agents that can be cited are cellulose and its derivatives, polyacrylamides, polyethylene oxides, polyethylene glycols, polyoxyethylenated polyoxypropylene glycols, polyacrylates, polyoxyethylenated alkylphenols, long chain polyoxyethylenated alcohols, polyvinylalcohols, alkanolamides, polyvinylpyrrolidone type dispersing agents, and xanthan gum based compounds.

The fluoridation treatment to obtain fluorine-containing compounds can be carried out using any known technique. Reference can in particular be made to the disclosure in the patent mentioned above, EP-A-0 628 608. This treatment can be carried out on the support prior to depositing the salt, hydroxide, oxide or derivative, or onto the composition.

In particular, the fluoridation agent can be a liquid, solid or gas. Preferably, the treatment conditions are such that the fluoridation agent is liquid or gaseous.

Examples of suitable fluorinating agents for carrying out the treatment of the invention that can in particular be cited are fluorine F₂, alkaline fluorides, ammonium fluoride, rare gas fluorides, nitrogen fluoride NF₃, boron fluoride BF₃, tetrafluoromethane, and hydrofluoric acid HF.

In the case of treatment carried out in a fluorinating atmosphere, the fluoridation agent can be used pure or diluted with a neutral gas, for example nitrogen.

The reaction conditions are preferably selected so that said treatment induces only surface fluoridation (mild conditions). In practice, the degree of progress of the fluoridation reaction can be monitored and controlled, for example by measuring the change in weight of the materials (weight increase caused by the introduction of fluorine).

The processes described above can be carried out one after the other. This means that acid attack is first carried out, optionally followed by neutralisation. Then optional fluoridation is carried out, then the transparent oxide can be deposited on the support followed by the zinc compound, in this order or in the reverse order. Fluoridation can also be carried out after depositing the zinc and/or transparent oxide.

In a variation of the process, the transparent oxide and the zinc compound can be deposited simultaneously by bringing the support, the transparent oxide precursor, the zinc precursor and the ammonia and/or ammonium salt into contact.

The present invention also concerns the use of the compositions described above or obtained by the preparation processes described above as coloring pigments.

The compositions or products of the invention have a coloring power and covering power that are suitable for coloring many materials such as plastics, paints and the like. They are particularly suitable for plastics formulations with an acidic nature, which can give rise to partial hydrolysis of the rare earth sulphide and/or in which they are used at a relatively high temperature.

More precisely, they can be used to colour polymers for plastics materials, either thermoplastics or thermosetting plastics, those polymers possibly containing traces of water.

Illustrative examples of thermoplastic resins that can be coloured in accordance with the invention are polyvinyl chloride, polyvinyl alcohol, polystyrene, styrene-butadiene, styrene-acrylonitrile or acrylonitrile-butadiene-styrene (ABS) copolymers, acrylic polymers such as polymethyl methacrylate, polyolefins such as polyethylene, polypropylene, polybutene, polymethylpentene, polybutylene terephthalate (PBT), cellulose derivatives such as cellulose acetate, cellulose acetobutyrate, ethylcellulose, and polyamides such as polyamide 6-6.

Examples of thermosetting resins which are suitable for use with the compositions of the invention that can be cited are phenolic plastics, aminoplasts, in particular urea-formaldehyde copolymers, melamine-formaldehyde copolymers, epoxy resins and thermosetting polyesters.

The compositions of the invention can also be used in special polymers such as fluoropolymers, in particular polytetrafluoroethylene (PTFE), polycarbonates, silicone elastomers, and polyimides.

In this specific application to colouring plastics, the compositions of the invention can be used directly in powder form. Preferably, they can be used in a pre-dispersed form, for example premixed with a portion of the resin, in the form of a concentrated paste or as a liquid, which means they can be introduced into any stage in the manufacture of the resin.

The products of the invention can be incorporated into plastics such as those mentioned above, in a proportion by weight which is generally either 0.01% to 5% (with respect to the final product), or 40% to 70% in the case of a concentrate.

The products of the invention can also be used in the paint and finishes industry, in particular in the following resins: alkyd resins, the most popular of which is glycerol-phthalic resin; long or short oil-modified resins; acrylic resins derived from esters of acrylic acid (methyl or ethyl) and methacrylic acid, which may be copolymerised with ethyl acetate, 2-ethylhexyl acetate or butyl acetate; vinyl resins such as polyvinyl acetate, polyvinyl chloride, polyvinyl butyral, polyvinyl formaldehyde, copolymers of vinyl chloride and vinyl acetate or vinylidene chloride, aminoplasts or phenolic resins, usually modified; polyester resins; polyurethane resins; epoxy resins; silicone resins.

In general, the products are used in a proportion of 5% to 30% by weight in a paint, and 0.1% to 5% in a finish.

Finally, the products of the invention are also suitable for applications in the rubber industry, in particular for floor coverings, in the paper industry and in printing inks, in the cosmetics industry, and in numerous other applications, non limiting examples of which are stains, finishing leather and in laminated coverings for kitchens and other work surfaces, in ceramics and in glazes.

The products produced by the process of the invention can also be used to colour materials based on or obtained from at least one mineral binder.

The mineral binder can be selected from hydraulic binders, air binders, plaster and anhydrous or partially hydrated calcium sulphate type binders.

The term “hydraulic binders” means substances with the property of setting and hardening after the addition of water by forming hydrates which are insoluble in water. The products of the invention are particularly applicable to colouring cements and, of course, concretes made from these cements by adding water, sand and/or gravel thereto.

Within the context of the present invention, the cement can, for example, be a high-alumina cement. This means any cement containing a high proportion of either alumina itself or an aluminate, or both. Examples are calcium aluminate based cements, in particular SECAR type cements.

The cement can also by a silicate type cement, in particular a cement based on calcium silicate. Examples are Portland cements, among them rapid set or very rapid set Portland cements, white cements, sulphate resistant cements and cements containing blast furnace slag and/or light ash and/or meta-kaolin.

Hemihydrate based cements, calcium sulphate based cements and magnesia “Sorel” cements can also be mentioned.

The products of the invention are also suitable for colouring air binders, i.e., binders which harden in the open air by the action of CO₂, of a calcium or magnesium oxide or hydroxide type.

Finally, the products of the invention are suitable for colouring plaster and anhydrous or partially hydrated calcium sulphate binders (CaSO₄ and CaSO₄, ½H₂O).

Finally, the invention concerns coloured compositions in particular of the plastic, paint, finish, rubber, ceramic, glaze, paper, ink, cosmetic product, dye, leather or laminated coating type or of the type based on or obtained from at least one mineral binder, comprising as the colouring pigment a composition in accordance with the invention or obtained by a process of the type described above.

Examples will now be given.

The test used to measure H₂S emission will be described below.

The test measured the quantity of H₂S released after extruding the pigment with polyamide 6.6 sold by Nyltech under the trade reference A216. The temperature of the co-rotating twin screw extruder was fixed at 270° C. Extrusion was carried out using a homogenized mixture containing: 1484 g of polymer, 15 g of pigment (dried in advance for 4 h at 130° C.) and 1 g of adhesion agent such as butyl stearate. The screw rotation rate was raised to and maintained at 120 rpm during extrusion. The extrudate was then granulated and 400 g was placed in a 1 litre polyethylene flask. After leaving for 30 minutes at ambient temperature, H₂S concentration measurements were made using “Dräger” or “Gastec” tubes provided with a metering pump. The error on the measurements was 10%.

### COMPARATIVE EXAMPLE 1

Reagents

The nature and proportions of the reactants are shown below. The cerium sulphide used was a sulphide with a γ cubic structure comprising sodium included in the crystalline lattice (Na/Ce atomic ratio=0.2).

| | | |
|---|---|---|
| Cerium sulphide | 100 | g |
| Ethanol 95% | 335 | g |
| Ammonia 32% | 52 | g |
| Ammonium fluoride | 5 | g |
| Zinc oxide | 10 | g |
| Ethyl silicate | 16 | g |
| Polyvinylpyrrolidone K10 MW = 10000 (PVP) | 2.5 | g |

Operating Protocol

The cerium sulphide was suspended in ethanol.

The ammonium fluoride solution was then added and stirring was maintained at ambient temperature for two hours. Then the sulphide underwent fluoridation treatment.

The PVP, dissolved in ethanol, was then added to the suspension.

The ammonia solution was added, then the zinc in the form of ZnO dispersed in ethanol. The ethyl silicate was then introduced continuously over two hours.

After introduction of the ethyl silicate was complete, the suspension was stirred for 2 hours. The particles obtained were washed with ethanol then dried for 4 h at 130° C.

### EXAMPLE 2

This example was an example in accordance with the invention, in which the support was treated with sulphuric acid.

Reagents

The cerium sulphide used was the same as that used in Example 1.

| | | |
|---|---|---|
| Cerium sulphide | 100 | g |
| Ethanol 95% | 265 | g |
| Ammonia 32% | 52 | g |
| H₂SO₄, 2N, diluted in water | 70 | ml |
| Zinc oxide | 10 | g |
| Ethyl silicate | 16 | g |
| Polyvinylpyrrolidone K10 MW = 10000 (PVP) | 2.5 | g |

Operating Protocol

The cerium sulphide was suspended in ethanol.

The sulphuric acid was then added over 1 hour and stirring was maintained at ambient temperature for 1 hour.

The PVP, dissolved in ethanol, was then added to the suspension.

The ammonia solution was added, then the zinc in the form of ZnO dispersed in ethanol. The ethyl silicate was then introduced continuously over two hours.

After introduction of the ethyl silicate was complete, the suspension was stirred for 2 hours.

The particles obtained were washed with ethanol then dried for 4 h at 130° C.

### EXAMPLE 3

Reagents

The cerium sulphide used was the same as that used in Example 1. In this example, neutralisation was carried out using ammonia.

| | | |
|---|---|---|
| Cerium sulphide | 100 | g |
| Ethanol 95% | 251 | g |
| Water | 100 | g |
| Ammonia 32% | 52 | g |
| H₂SO₄, 2N, diluted in water | 42 | ml |
| Ammonia, N | 42 | ml |
| Zinc oxide | 10 | g |
| Ethyl silicate | 16 | g |
| Polyvinylpyrrolidone K10 MW = 10000 (PVP) | 2.5 | g |

Operating Protocol

The cerium sulphide was suspended in ethanol.

The sulphuric acid solution was then added over 1 hour along with the base (N ammonia) and stirring was maintained at ambient temperature for 0.5 hour.

The suspension was filtered to eliminate the maximum amount of water, then taken up again in suspension in ethanol.

The PVP, dissolved in ethanol, was then added to the suspension.

The ammonia solution (32% solution) was added, then the zinc in the form of ZnO dispersed in ethanol. The ethyl silicate was then introduced continuously over two hours.

After introduction of the ethyl silicate was complete, the suspension was stirred for 2 hours.

The particles obtained were washed with ethanol then dried for 4 h at 130° C.

### EXAMPLE 4

Reagents

The cerium sulphide used was the same sulphide as that used in Example 1. The acid used here was phosphoric acid.

| | | |
|---|---|---|
| Cerium sulphide | 100 | g |
| Ethanol 95% | 293 | g |
| Ammonia 32% | 52 | g |
| H₃PO₄, N, diluted in water | 42 | ml |
| Zinc oxide | 10 | g |
| Ethyl silicate | 16 | g |
| Polyvinylpyrrolidone K10 MW = 10000 (PVP) | 2.5 | g |

Operating Protocol

The cerium sulphide was suspended in ethanol.

The phosphoric acid solution was then added over 1.5 hour and stirring was maintained at ambient temperature for 0.5 hour.

The PVP, dissolved in ethanol, was then added to the suspension.

The ammonia solution was added, then the zinc in the form of ZnO dispersed in ethanol. The ethyl silicate was then introduced continuously over two hours.

After introduction of the ethyl silicate was complete, the suspension was stirred for 2 hours.

The particles obtained were washed with ethanol then dried for 4 h at 130° C.

### EXAMPLE 5

Reagents

The cerium sulphide used was the same sulphide as that used in Example 1. The acid used was nitric acid and neutralisation was carried out using ammonia.

| | | |
|---|---|---|
| Cerium sulphide | 100 | g |
| Ethanol 95% | 293 | g |
| Ammonia 32% | 52 | g |
| HNO₃, N, diluted in water | 21 | ml |
| Ammonia, N | 21 | ml |
| Zinc oxide | 10 | g |
| Ethyl silicate | 16 | g |
| Polyvinylpyrrolidone K10 MW = 10000 (PVP) | 2.5 | g |

Operating Protocol

The cerium sulphide was suspended in ethanol.

The nitric acid solution and ammonia solution (N ammonia) were then added over 1.5 hours. Stirring was maintained at ambient temperature for 0.5 hour.

The PVP, dissolved in ethanol, was then added to the suspension.

The ammonia solution (32% solution) was added, then the zinc in the form of ZnO dispersed in ethanol. The ethyl silicate was then introduced continuously over two hours.

After introduction of the ethyl silicate was complete, the suspension was stirred for 2 hours.

The particles obtained were washed with ethanol then dried for 4 h at 130° C. The table below shows the results obtained in the H₂S emission test.

### EXAMPLE 6

Reagents

The cerium sulphide used was the same sulphide as that used in Example 1. The acid used was nitric acid and neutralisation was carried out using ammonia but in the presence of hydrogen peroxide.

| | | |
|---|---|---|
| Cerium sulphide | 100 | g |
| Ethanol 95% | 293 | g |
| Ammonia 32% | 52 | g |
| HNO₃, N, diluted in water | 21 | ml |
| Ammonia, N | 21 | ml |
| H₂O₂, 30% | 3 | ml |
| Zinc oxide | 10 | g |
| Ethyl silicate | 16 | g |
| Polyvinylpyrrolidone K10 MW = 10000 (PVP) | 2.5 | g |

Operating Protocol

The cerium sulphide was suspended in ethanol.

The nitric acid solution and ammonia solution (N ammonia) mixed with the hydrogen peroxide were then added simultaneously over 1.5 hours. Stirring was maintained at ambient temperature for 0.5 hour.

The PVP, dissolved in ethanol, was then added to the suspension.

The ammonia solution (32% solution) was added, then the zinc in the form of ZnO dispersed in ethanol. The ethyl silicate was then introduced continuously over two hours.

After introduction of the ethyl silicate was complete, the suspension was stirred for 2 hours.

The particles obtained were washed with ethanol then dried for 4 h at 130° C. The table below shows the results obtained in the H₂S emission test.

| Examples | H₂S emissions (ppm) |
|---|---|
| 1 | 300 |
| 2 | 50 |
| 3 | 80 |
| 4 | 90 |
| 5 | 200 |
| 6 | 70 |

1. A composition, characterized in that it contains:
a support based on a rare earth sulphide;
a layer based on at least one salt of said rare earth sulphide, a hydroxide, an oxide of said rare earth or an oxy and/or hydroxy derivative thereof, the salt, hydroxide, oxide and the derivative being insoluble in water and/or in alcohols.

2. A composition according to claim 1, characterized in that the layer based on at least one salt, a hydroxide, an oxide or said derivative has been obtained by acid attack of the rare earth sulphide.

3. A composition according to claim 1 or claim 2, characterized in that said salt is a sulphate or a phosphate.

4. A composition according to one of the preceding claims, characterized in that the sulphide is a sulphide of a rare earth and an alkali.

5. A composition according to one of claims 1 to 3, characterized in that the sulphide contains at least one alkali and/or alkaline-earth element at least a portion of which is included in the crystalline lattice of said sulphide.

6. A composition according to claim 5, characterized in that the sulphide is a rare earth sesquisulphide.

7. A composition according to claim 6, characterized in that the rare earth sesquisulphide is a γ cubic Ce₂S₃ sesquisulphide.

8. A composition according to one of the preceding claims, characterized in that it also comprises a layer based on at least one transparent oxide deposited on the support.

9. A composition according to claim 8, characterized in that the transparent oxide is silica or a silica-alumina mixture.

10. A composition according to one of the preceding claims, characterized in that it further comprises a layer based on at least one zinc compound, in particular zinc oxide, deposited on the support.

11. A composition according to one of the preceding claims, characterized in that it further comprises fluorine.

12. A process for preparing a composition according to one of the preceding claims, characterized in that attack is carried out with an acid on the surface of said support and in that said attack is optionally followed by neutralisation.

13. A process according to claim 12, characterized in that the acid attack and optional neutralisation are carried out in an alcoholic medium.

14. A process according to claim 12 or claim 13, for the preparation of a composition that further comprises a layer based on at least one transparent oxide, characterized in that subsequently to the acid attack on the support and optional neutralisation, the support and a precursor for the transparent oxide are brought into contact and the transparent oxide is precipitated onto said support.

15. A process according to claim 12 or claim 13, for the preparation of a composition that comprises a layer based on at least one zinc compound characterized in that, subsequently to the acid attack on the support and optional neutralisation, the support, a zinc precursor, ammonia and/or an ammonium salt are brought into contact and the zinc compound is deposited onto said support.

16. A process according to one of claims 12 to 15, characterized in that the support or the composition undergoes a fluoridation treatment.

17. A process according to one of claims 12 to 16, characterized in that the acid attack is carried out in the presence of an oxidizing agent.

18. Use of a composition according to any one of claims 1 to 10 or obtained by a process according to any one of claims 12 to 17 as a coloring pigment.

19. Use according to claim 18, characterized in that the composition is used as a pigment in plastics materials, paints, finishes, rubbers, ceramics, glazes, papers, inks, cosmetics products, dyes, leathers, laminated coating and materials based on or obtained from at least one mineral binder.

20. Compositions of coloured materials, in particular of the plastic, paint, finish, rubber, ceramic, glaze, paper, ink, cosmetic product, dye, leather, laminated coating type or of the type based on or obtained from at least one mineral binder, characterized in that they comprise, as the colouring pigment, a composition according to one of claims 1 to 10 or obtained by a process according to one of claims 12 to 17.
